(19) United States
(12) Patent Application Publication
(10) Pub. No.: US 2023/0304832 A1
(43) Pub. Date: Sep. 28, 2023

(54) CONTINUOUS SPATIAL SYNCHRONIZATION MONITORING DEVICE FOR OCEAN TEMPERATURE AND PRESSURE

(71) Applicant: SHANDONG ACADEMY OF SCIENCES, Jinan, Shandong (CN)

(72) Inventors: Yinglong WANG, Jinan (CN); Chang WANG, Jinan (CN); Jiasheng NI, Jinan (CN); Ying SHANG, Jinan (CN); Chen WANG, Jinan (CN); Xiaohui LIU, Jinan (CN); Zhiqiang SONG, Jinan (CN); Yingying WANG, Jinan (CN)

(73) Assignee: SHANDONG ACADEMY OF SCIENCES, Jinan, Shandong (CN)

(21) Appl. No.: 18/019,674

(22) PCT Filed: Jul. 6, 2020
(86) PCT No.: PCT/CN2020/100404

§ 371 Date: Feb. 3, 2023

(51) Int. Cl. G01D 5/353

(52) U.S. Cl. CPC G01D 5/35361; G01D 5/35316; G01D 5/35387

(57) ABSTRACT

The present application provides a continuous spatial synchronization monitoring device for an ocean temperature and pressure. Broadband light output by a broadband light source is converted into broadband pulsed light by using a pulse controller; then, the broadband pulsed light is demodulated by using a phase shifted fiber bragg grating unit to obtain pulsed light having multiple different wave-lengths; the pulsed light is incident to a sensing optical fiber in seawater by means of a wavelength division multiplexer; according to a Rayleigh scattering principle, backward Rayleigh scattering light returns to a control demodulation module by means of the wavelength division multiplexer; the control demodulation module performs demodulation on the backward Rayleigh scattering light, analyzes a dynamic pressure according to a phase change of a light signal, and analyzes a seawater temperature according to a wavelength change, thereby simultaneously monitoring both the pressure and temperature.

### FIELD OF THE PRESENT DISCLOSURE

The present application relates to the technical field of ocean environment monitoring, and particularly relates to a continuous spatial synchronization monitoring device for ocean temperature and pressure.

### BACKGROUND OF THE PRESENT DISCLOSURE

Ocean is vast in area and changes rapidly, and it is an important factor influencing natural disasters such as global climate changing, flood, drought and typhoon, so ocean environment is of great significance to weather forecast and disaster early warning. The measurement on seawater temperature and pressure is of great significance to the research of oceanography, ocean environment monitoring, etc. For example, in the fields of ocean scientific investigation and military affairs it is necessary to obtain dynamic changes of the ocean temperature profile and pressure in time.

At present, most of ocean temperature and pressure monitoring devices are electrical devices, most of which have the problems such as high price, large size, difficult arrangement and susceptible to electromagnetic interference. In addition, the temperature and pressure data are respectively subjected to monitoring and signal processing by discrete electronic devices. A large number of sensor combination arrays are needed to realize large-range monitoring of the sea area. Therefore, there are problems of huge investment, complex system, low reliability, difficult data compatibility and comprehensive processing, etc.

In view of this, in order to adapt to the development requirement of ocean planning, it is needed to vigorously develop ocean temperature and pressure monitoring devices which have strong data compatibility, low cost and compact structure and meet the requirement of high-precision in-situ measurement.

### SUMMARY OF THE PRESENT DISCLOSURE

In order to solve above problems, an embodiment of the present application provides a continuous spatial synchronization monitoring device for an ocean temperature and pressure.

In one embodiment, the continuous spatial synchronization monitoring device for the ocean temperature and pressure provided by the present application includes:
a multi-wavelength laser module which includes a broadband light source, a pulse controller and a phase shifted fiber bragg grating unit, the pulse controller being configured to convert broadband light output by the broadband light source into broadband pulsed light, and the phase shifted fiber bragg grating unit being configured to demodulate the pulsed light arranged by a time sequence and having multiple different wave-lengths from the broadband pulsed light;
a first wavelength division multiplexer of which a first port is connected to an output end of the multi-wavelength laser module, and a second port is connected to a sensing optical fiber for injecting the pulsed light having different wave-lengths into the sensing optical fiber;
the sensing optical fiber placed in seawater, wherein backward Rayleigh scattering light may be generated when the pulsed light having different wave-lengths is transmitted in the sensing optical fiber;
a control demodulation module which is connected to the second port of the first wavelength division multiplexer for receiving the backward Rayleigh scattering light, demodulating the backward Rayleigh scattering light and calculating temperature and pressure values of the seawater at all points around the sensing optical fiber.

In a second embodiment, the multi-wavelength laser module further includes a second wavelength division multiplexer,
wherein a first port of the second wavelength division multiplexer is connected to an output end of the pulse controller, a second port of the second wavelength division multiplexer is connected to the phase shifted fiber bragg grating unit, and a third port of the second wavelength division multiplexer is connected to the first port of the first wavelength division multiplexer; and
the phase shifted fiber bragg grating unit includes an optical fiber, and multiple reflective phase shifted fiber bragg gratings having different central window wave-lengths are arranged on the optical fiber.

In a third embodiment, the multi-wavelength laser module further includes the second wavelength division multiplexer,
wherein the first port of the second wavelength division multiplexer is connected to the output end of the pulse controller, the second port of the second wavelength division multiplexer is connected to the phase shifted fiber bragg grating unit, and the third port of the second wavelength division multiplexer is connected to the first port of the first wavelength division multiplexer;
the phase shifted fiber bragg grating unit includes multiple optical fibers; a reflective phase shifted fiber bragg grating is arranged on each optical fiber; and the central window wave-lengths of the phase shifted fiber bragg gratings on all the optical fibers are different.

In a fourth embodiment, the phase shifted fiber bragg grating unit includes multiple optical fibers; a transmissive phase shifted fiber bragg grating is arranged on each optical fiber; and the central window wave-lengths of the phase shifted fiber bragg gratings on all the optical fibers are different;
one end of each optical fiber is connected to the output end of the pulse controller, and the other end of each optical fiber is connected to the first port of the first wavelength division multiplexer.

In a fifth embodiment, the multi-wavelength laser module further includes an erbium-doped fiber amplifier,
wherein the erbium-doped fiber amplifier is connected to first port of the first wavelength division multiplexer for amplifying an amplitude of multiple pieces of pulsed light having different wave-lengths and then outputting the pulsed light to the first port of the first wavelength division multiplexer.

In a sixth embodiment, the control demodulation module includes a coupler, a first interference arm, a second interference arm, Faraday rotator mirrors, photoelectric detectors and an acquisition processing unit,
wherein a first end of the coupler is connected to a third port of the first wavelength division multiplexer, and a second end of the coupler is connected with one end of the first interference arm and one end of the second interference arm; the other end of the first interference arm and the other end of the second interference arm are respectively connected to the Faraday rotator mirrors; the length of the first interference arm is not equal to that of the second interference arm;
the photoelectric detectors are all connected to a third end of the coupler for receiving backward Rayleigh scattering interference light returned by the first interference arm and the second interference arm and generating corresponding electric signals according to the backward Rayleigh scattering interference light;
the acquisition processing unit is connected to the photoelectric detectors for processing the electric signals output by the photoelectric detectors and demodulating phase changes, caused by a disturbance signal in the sensing optical fiber, of the pulsed light of one wavelength and power changes of the backward Rayleigh scattering light, caused by temperature change, of the pulsed light of each wavelength.

In a seventh embodiment, the control demodulation module includes the coupler, the first interference arm, the second interference arm, the Faraday rotator mirrors, a first photoelectric detector, a second photoelectric detector, a third photoelectric detector and the acquisition processing unit,
wherein the first end of the coupler is connected to the third port of the first wavelength division multiplexer, and the second end of the coupler is connected to one end of the first interference arm and one end of the second interference arm; the other end of the first interference arm and the other end of the second interference arm are respectively connected to the Faraday rotator mirrors; the length of the first interference arm is not equal to that of the second interference arm;
the first photoelectric detector, the second photoelectric detector and the third photoelectric detector are all connected to the coupler for receiving the backward Rayleigh scattering interference light returned by the first interference arm and the second interference arm and generating corresponding electric signals according to the backward Rayleigh scattering interference light;
the acquisition processing unit is connected to the first photoelectric detector, the second photoelectric detector and the third photoelectric detector for processing the electric signals output by the first photoelectric detector, the second photoelectric detector and the third photoelectric detector, and demodulating the phase change, caused by disturbance signal in the sensing optical fiber, of the pulsed light of one wavelength and power changes of the backward Rayleigh scattering light, caused by the temperature change, of the pulsed light of each wavelength.

In an eighth embodiment, the control demodulation module includes the first interference arm, the second interference arm, the photoelectric detectors and the acquisition processing unit,
wherein the third port of the first wavelength division multiplexer is connected to one end of the first interference arm and one end of the second interference arm respectively, and the other end of the first interference arm and the other end of the second interference arm are connected to the photoelectric detectors respectively;
the photoelectric detectors are configured to receive the backward Rayleigh scattering interference light output by the first interference arm and the second interference arm and generate corresponding electric signals according to the backward Rayleigh scattering interference light;
the acquisition processing unit is connected to the photoelectric detectors for processing the electric signals output by the photoelectric detectors, and demodulating the phase change, caused by disturbance signal in the sensing optical fiber, of the pulsed light of one wavelength and power changes of the backward Rayleigh scattering light, caused by the temperature change, of the pulsed light of each wavelength.

In a ninth embodiment, the acquisition processing unit is also connected with a control end of the pulse controller for outputting a pulse control signal to the pulse controller so as to control the output of the broad-spectrum pulsed light of the pulse controller.

According to the continuous spatial synchronization monitoring device for the ocean temperature and pressure provided by the embodiment, as shown in the abovementioned embodiments, the pulse controller is configured to convert the broadband light output by the broadband light source into the broadband pulsed light, and then the phase shifted fiber bragg grating unit performs demodulation on the pulsed light having different wave-lengths from the broadband pulsed light. The pulsed light is incident to the sensing optical fiber in seawater through the wavelength division multiplexers. The backward Rayleigh scattering light is returned to the control demodulation module through the wavelength division multiplexers according to the Rayleigh scattering principle. The control demodulation module performs demodulation on the backward Rayleigh scattering light, analyzes the dynamic pressure according to the phase change of the optical signals, and analyzes the seawater temperature according to the wavelength change, thereby simultaneously monitoring both the dynamic pressure and temperature. According to the embodiments, multi-parameter continuous spatial measurement is achieved by means of distributed measurement based on the Rayleigh scattering principle, and a two-dimensional profile of space and temperature and pressure changes is formed, such that large-data-volume and multi-dimensional high-value ocean environment information can further be provided. In addition, in the embodiments of the present application, the sensing optical fiber is used, so that transmission and sensing are integrated, the laying is easy, and high temperature resistance and corrosion resistance are achieved.

### BRIEF DESCRIPTION OF THE DRAWINGS

In order to more clearly explain the technical solution of the present application, the following will briefly introduce the accompanying drawings needed in the embodiments. It is obvious that for ordinary technicians in the art, other drawings can also be obtained from these drawings without paying creative labor.

FIG. 1 is a basic structure schematic diagram of a continuous spatial synchronization monitoring device for an ocean temperature and pressure provided by an embodiment of the present application;

FIG. 2 is a basic structure schematic diagram of a first multi-wavelength laser module provided by an embodiment of the present application;

FIG. 3 is a basic structure schematic diagram of a second multi-wavelength laser module provided by an embodiment of the present application;

FIG. 4 is a basic structure schematic diagram of a third multi-wavelength laser module provided by an embodiment of the present application;

FIG. 5 is a schematic diagram of laser spectrums output by a multi-wavelength laser module and arranged by a time sequence according to an embodiment of the present application;

FIG. 6 is a basic structure schematic diagram of a first control demodulation module provided by an embodiment of the present application;

FIG. 7 is a basic structure schematic diagram of a second control demodulation module provided by an embodiment of the present application; and

FIG. 8 is a basic structure schematic diagram of a third control demodulation module provided by an embodiment of the present application.

### DESCRIPTION OF THE EMBODIMENTS

Exemplary embodiments will be described in detail herein, and examples thereof are shown in the accompanying drawings. When the following description relates to the accompanying drawings, unless otherwise indicated, the same numbers in different accompanying drawings represent the same or similar elements. The embodiments described in the following exemplary embodiments do not represent all embodiments consistent with the present application. On the contrary, they are only examples of devices and methods consistent with some aspects of the present application as detailed in the attached claims.

Existing ocean electronic monitoring equipment is susceptible to electromagnetic interference and corrosion of damp, mould and salt mist ocean environments, and is difficult to meet the needed measurement precision and long-time monitoring requirements. According to the embodiment, lasers emitted by a multi-wavelength laser module are emitted into a sensing optical fiber in seawater through wavelength division multiplexers. Backward Rayleigh scattering light is returned to a control demodulation module through the wavelength division multiplexers according to the Rayleigh scattering principle. The control demodulation module analyzes a dynamic pressure according to a phase change of a laser, and analyzes a seawater temperature according to a wavelength change, thereby simultaneously monitoring both the dynamic pressure and temperature. Based on this principle, a continuous spatial synchronization monitoring device for an ocean temperature and pressure provided by this embodiment is illustrated as follows in detail in conjunction with the accompanying drawings.

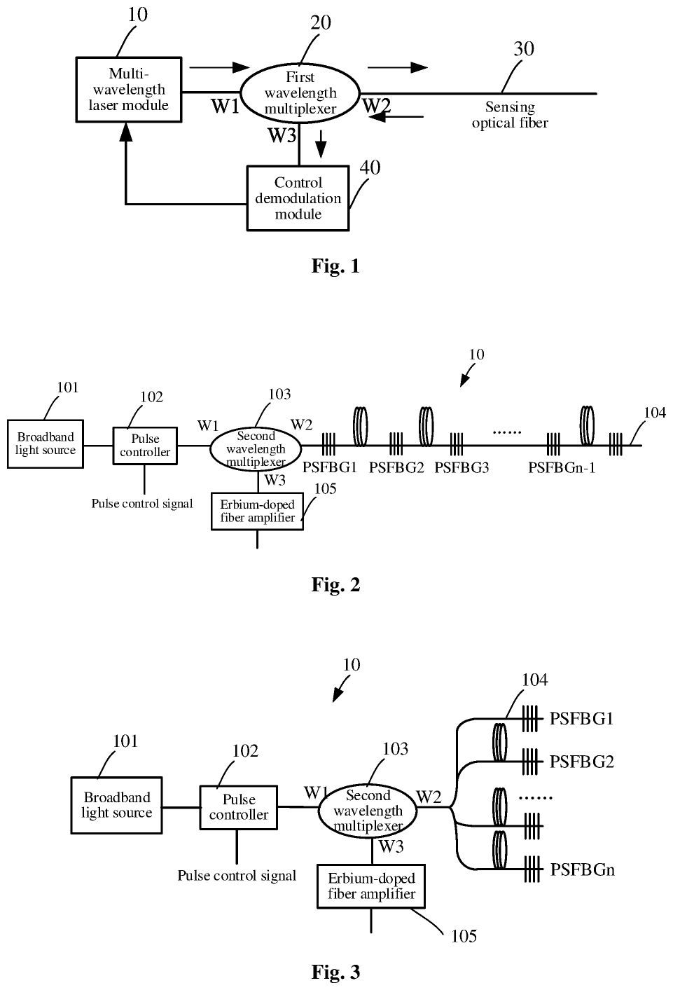

FIG. 1 is the basic structure schematic diagram of the continuous spatial synchronization monitoring device for the ocean temperature and pressure provided by the embodiment of the present application. As shown in FIG. 1, the device includes a multi-wavelength laser module 10, a first wavelength division multiplexer 20, a sensing optical fiber 30 and a control demodulation module 40.

The multi-wavelength laser module 10 includes a broadband light source, a pulse controller and a phase shifted fiber bragg grating unit, wherein the pulse controller is configured to convert broadband light output by the broadband light source into broadband pulsed light; and the phase shifted fiber bragg grating unit performs demodulation on pulsed light having different wave-lengths from the broadband pulsed light.

A Phase Shifted Fiber Bragg Grating (PSFBG) in the phase shifted fiber bragg grating unit can realize reflection or transmission of the laser, and the bandwidths of a transmission spectrum and a reflection spectrum are extremely narrow. According to the embodiment, optical fiber bragg grating is classified into a transmissive phase shifted fiber bragg grating and a reflective phase shifted fiber bragg grating according to the demodulating mode of the phase shifted fiber bragg grating to the laser. Based on the type of the phase shifted fiber bragg grating, the broadband light source in the multi-wavelength laser module 10, the pulse controller and the phase shifted fiber bragg grating unit may have three different structural forms.

FIG. 2 is the basic structure schematic diagram of the first multi-wavelength laser module provided by the embodiment of the present application. As shown in the FIG. 2, the multi-wavelength laser module includes a broadband light source 101, a pulse controller 102, a second wavelength division multiplexer 103 and a phase shifted fiber bragg grating unit 104.

An output end of the broadband light source 101 is connected to an input end of the pulse controller 102 for outputting broadband light laser having small coherence length to the pulse controller 102, for example, laser having the line width of hundreds of MHz or above. The pulse controller 102 can be an electro-optical modulator, an acoustic optical modulator or a combination of the electro-optical modulator and the acoustic optical modulator, and the pulse controller 102 is configured to convert the broadband light laser into broadband pulsed light based on a received pulse control signal. For example, if the pulse control signal is at a low level, the pulse controller 102 does not output light; and if the pulse control signal is at a high level, the pulse controller 102 outputs light, so that the output of the broadband light pulse signal is realized. The pulse control signal received by the pulse controller 102 can be output by the control demodulation module 40, and certainly, a pulse control signal output module can be additionally arranged. It is to be noted that in the embodiment, the laser signal received by the pulse controller 102 is the broadband light laser, so that the pulse signal output by the pulse controller 102 is referred to as the broadband pulsed light.

A first port W1 of the second wavelength division multiplexer 103 is connected to an output end of the pulse controller 102, a second port W2 of the second wavelength division multiplexer is connected to the phase shifted fiber bragg grating unit 104, and a third port W3 of the second wavelength division multiplexer is connected to a first port W1 of a first wavelength division multiplexer 20. The broadband pulsed light output by the pulse controller 102 passes through the first port W1 and the second port W2 of the second wavelength division multiplexer 103. The phase shifted fiber bragg grating unit includes an optical fiber, and multiple reflective phase shifted fiber bragg gratings having different central window wave-lengths are arranged on the optical fiber. For example, in this embodiment, n phase shifted fiber bragg gratings are etched in an erbium-doped fiber, and the central window wave-lengths are λ₁, λ₂, λ₃, λ₄, λ₅, λ₆ . . . λₙ₋₁ and λₙ respectively. The broadband pulsed light output by the pulse controller 102 passes through the second wavelength division multiplexer 103, then enters the optical fiber, passes through a PSFBG1, then is demodulated into pulsed light having the wavelength λ₁, and returns to the third port W3 through the second port W2 of the second wavelength division multiplexer 103. The light of other wave-lengths passes through the optical fiber (referred to as a delay optical fiber in the embodiment) between the PSFBG1 and a PSFBG2, is transmitted to the PSFBG2, passes through the PSFBG2, then is demodulated into pulsed light having the wavelength λ₂, and returns to the third port W3 through the second port W2 of the second wavelength division multiplexer 103. Similarly, the pulsed light of other wave-lengths is demodulated after passing through the rest PSFBGs, and then the pulsed light having different wave-lengths arranged by a time sequence can be obtained. Moreover, the time interval between the pulsed light of all wave-lengths can be set by setting the length of the delay optical fiber between the PSFBGs.

Further, in order to amplify an optical signal output by the third port W3 of the second wavelength division multiplexer 103, as shown in FIG. 3, the embodiment also provides an erbium-doped fiber amplifier 105, wherein one end of the erbium-doped fiber amplifier 105 is connected to the third port W3 of the second wavelength division multiplexer 103, and the other end of the erbium-doped fiber amplifier 105 is connected to the first port W1 of the first wavelength division multiplexer 20 for amplifying an amplitude of the pulsed light having different wave-lengths and output by the second wavelength division multiplexer 103 and then outputting the pulsed light to the first port W1 of the first wavelength division multiplexer 20. Certainly, in other embodiments, optical signal amplifiers of may be other type, such as a ytterbium-doped fiber amplifier.

FIG. 3 is the basic structure schematic diagram of the second multi-wavelength laser module provided by the embodiment of the present application. As shown in FIG. 3, the main difference between this embodiment and the multi-wavelength laser module is that the phase shifted fiber bragg grating unit 104 is composed of multiple optical fibers, a reflective phase shifted fiber bragg grating is etched in each optical fiber, and the central window wave-lengths of the phase shifted fiber bragg gratings on the optical fibers are different. Therefore, the pulsed light having different wave-lengths can be obtained after being incident into each optical fiber through the second port W2 of the second wavelength division multiplexer 103; and moreover, laser spectra of different wave-lengths arranged by time sequence can be obtained by setting the length of a delay optical fiber in each optical fiber.

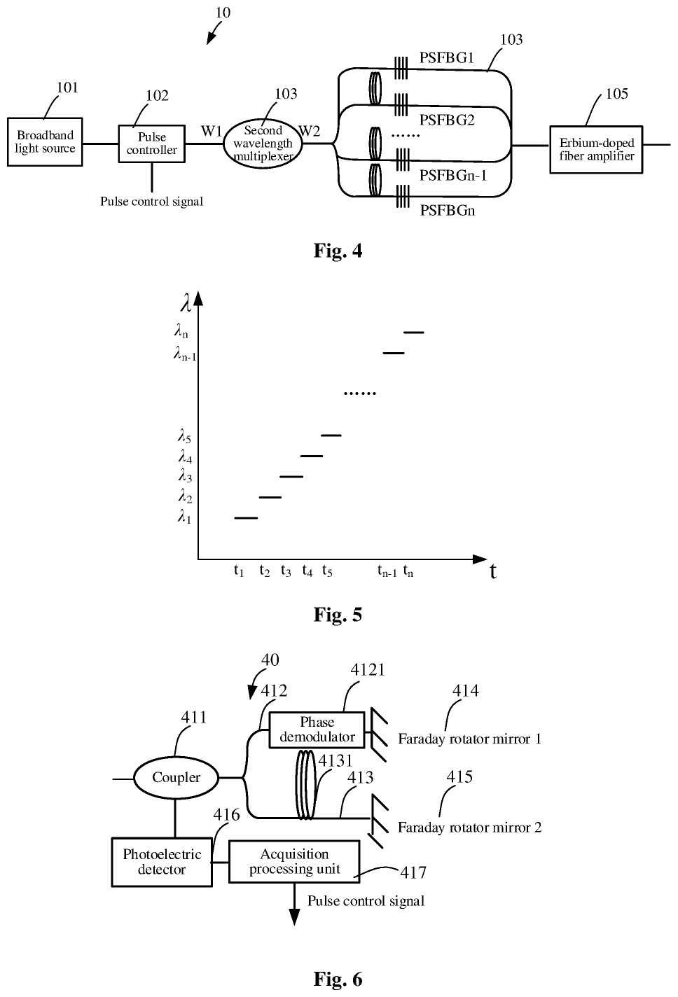

FIG. 4 is the basic structure schematic diagram of the third multi-wavelength laser module provided by the embodiment of the present application. As shown in FIG. 4, the main difference between this embodiment and the second multi-wavelength laser module is that the phase shifted fiber bragg grating on the optical fiber is a transmissive phase-shifting optical fiber; and further, in this embodiment, the second port W2 of the second wavelength division multiplexer 103 is connected to one end of the phase shifted fiber bragg grating unit 104, and the other end of the phase shifted fiber bragg grating unit 104 is connected to an input port of the erbium-doped fiber amplifier 105.

It is to be noted that an internal structure of the multi-wavelength laser module 10 in other embodiments can be a combination structure of any two or three of the abovementioned embodiments.

Through the configuration above, the pulsed light of respective wave-length output by the multi-wavelength laser module 10 enters the sensing optical fiber 30 through the first wavelength division multiplexer 20. FIG. 5 is the schematic diagram of laser spectrums output by the multi-wavelength laser module and arranged by the time sequence according to the embodiment of the present application. As shown in FIG. 5, optical pulses output by the multi-wavelength laser module 10 output wavelength sequences λ (λ1, λ2 . . . λn−1, λn) in time sequences T (t1, t2 . . . tn−1 and tn), and the following conditions are met:

tₙ=tₙ₋₁=Lₙ/v_{g}(n≥2) (1)

tₙ−t₁=W (2)
wherein Ln represents the length of the n^{th} delay optical fiber, W represents the pulse width of the pulse control signal, and ν_{g} represents the transmission speed of light in an optical fiber medium.

The sensing optical fiber 30 is arranged in seawater, and the sensing optical fiber 30 can be vertically and directly communicated to the seabed. The sensing optical fiber 30 is vertically connected to a deep water anchoring and mooring device on the seabed. The deep water anchoring and mooring device can use an anchor for mooring a ship, and the anchor is directly connected to a lower end of the sensing optical fiber 30.

The sensing optical fiber 30 is vertically communicated to the seabed through the deep water anchoring and mooring device, so that the temperature distribution and pressure of each point on the sensing optical fiber 30 are the temperature field and pressure distribution of the ocean vertically distributed along the depth. The sensing optical fiber 30 has strong seawater corrosion resistance, seawater side pressure resistance under the sea surface of tens of thousands of meters and tensile resistance.

Further, the coherent length of pulsed light output by the multi-wavelength laser module 10 adopted by the embodiment is low. In order to realize interference adjustment demodulation, the embodiment abandons a traditional method of interference of backward Rayleigh scattering light and laser local oscillation light, and adopts a backward Rayleigh scattering light self-interference method to realize signal demodulation.

Two circumstances of non-uniform optical fiber density caused by thermal disturbance and impure optical fiber concentration (such as oxide having non-uniform concentration) are main reasons of non-uniform optical fiber refractive index. The size of a non-uniform structure in the optical fiber is generally smaller than the wavelength of incident light, so that the incident light may generate a Rayleigh scattering phenomenon when being transmitted in the sensing optical fiber 30.

The power of pulsed light incident into the optical fiber is set as P₀, and the expression of backward Rayleigh scattering light power P_{BS}(L) at a position L away from an initial end of the sensing optical fiber 30 is shown as follows:

P_{BS}(L)=½ν_{g}τC_{R}αₛP₀e^{-2αL} (3)

In the Formula (3), ν_{g} represents the transmission speed of light in the optical fiber medium; τ represents the width of the pulsed light incident into the optical fiber; C_{R} represents the backward Rayleigh scattering coefficient, namely the ratio of the backward Rayleigh scattering power to the total Rayleigh scattering power; αₛ represents a Rayleigh attenuation coefficient; a represents an optical fiber attenuation coefficient; and L represents a distance from the initial end of the optical fiber to a scattering point.

The Formula (1) represents the scattering power at different positions on the sensing optical fiber 30, and the distributed measurement of the whole optical fiber can be realized by monitoring the light power, namely continuous space measurement of parameters can be realized.

If the temperature on the sensing optical fiber is not changed, backward Rayleigh scattering curves measured at different moments are the same; and if the temperature on the sensing optical fiber is changed, the backward Rayleigh scattering curves before the temperature change can be restored by searching the incident light frequency.

It is assumed that the temperature of the sensing optical fiber 30 at the initial moment a is 25° C., the backward Rayleigh scattering light power Pa (v, z) on the sensing optical fiber can be obtained through the incident frequency v of the multi-wavelength laser module 10. The backward Rayleigh scattering light power Pb (v, z) can be measured at the moment b by the same method. If the temperature of the sensing optical fiber at the moment a and the moment b is not changed, Pb (v, z) is the same as the Pa (v, z); if the temperature or strain is changed, and the incident frequency is searched to reach v+Δv, Pb (v+Δv, z) is the same as Pa (v, z). Δv represents a frequency variation of the incident frequency and is related to the temperature change on the sensing optical fiber, which means that the temperature or strain change on the sensing optical fiber causes the movement of the backward Rayleigh scattering light power Pb (v, z) on a frequency domain.

In summary, the backward Rayleigh scattering light power Pa (v, z) and Pb (v, z) generated at the moment a and the moment b are subjected to correlation processing, and correlation function reaching the maximum value corresponds to the variation of the frequency of corresponding incident light. Therefore, the distribution information of the temperature on the sensing optical fiber 30 can be obtained by calculating the peak frequency of the frequency spectrum of the correlation function. That is, the control demodulation module 40 can obtain the distribution information of the temperature on the sensing optical fiber 30 according to the backward Rayleigh scattering light power change of the pulsed light of each wavelength caused by the temperature change at each point on the sensing optical fiber 30, and then a temperature field of ocean distributed along the depth can be obtained.

Meanwhile, the backward Rayleigh scattering light wavelength sequence enters the control demodulation module 40, and the phase of a fixed wavelength in backward Rayleigh scattering light can be demodulated, so that the dynamic pressure of seawater can be analyzed. According to different forms of control demodulation modules, a Phase Generated Carrier (PGC) or 3×3 coupler phase demodulation solution is adopted in the embodiment for demodulating the self-interference phase of the backward Rayleigh scattering light.

FIG. 6 is the basic structure schematic diagram of the first control demodulation module provided by the embodiment of the present application. As shown in FIG. 6, the embodiment adopts a PGC demodulation mode based on a Michelson interferometer; and this module mainly includes a coupler 411, a first interference arm 412, a second interference arm 413, Faraday rotator mirrors 414/415, photoelectric detectors 416 and an acquisition processing unit 417.

A first end of the coupler 411 is connected to the second port of the first wavelength division multiplexer 20, a second end of the coupler 411 is connected to one end of the first interference arm 412 and one end of the second interference arm 413, and the other end of the first interference arm 412 and the other end of the second interference arm 413 are connected to the Faraday rotator mirrors 414 and 415 respectively. In addition, a phase modulator 4121 is arranged on the first interference arm 412; a phase matching ring 4131 is arranged on the second interference arm 413, and the length L of the phase matching ring 4131 meets the condition L≤Lo/2, wherein Lₒ represents the coherence length of pulsed light. Certainly, the phase matching ring 4131 can also be arranged on the first interference arm 412.

The photoelectric detectors 416 are connected to a third end of the coupler 411 for receiving the backward Rayleigh scattering interference light returned by the first interference arm 412 and the second interference arm 413 and generate corresponding electric signals according to the backward Rayleigh scattering interference light. The acquisition processing unit 417 is connected to the photoelectric detectors 416 for processing the electric signals output by the photoelectric detector 416 and demodulating phase change of the pulsed light of one wavelength caused by a disturbance signal in the sensing optical fiber so as to monitor the seawater pressure, to realize the monitoring of the seawater temperature. In addition, the seawater temperature can be monitored according to the power change of the backward Rayleigh scattering light of the pulsed light of each wavelength caused by temperature change.

Specifically, for phase demodulation, according to the light coherence principle, the light intensity I on the photoelectric detectors 416 can be expressed as follows:

I=A+B cos ϕ(t) (4)

In the Formula (4), A represents an average light power output by the interferometer; B represents an interference signal amplitude, B=κA, wherein κ≤1 and represents an interference fringe visibility. ϕ(t) represents a phase difference of the interferometer. If ϕ(t)=C cos ω₀t+ϕ(t), the Formula (2) can be written as follows:

I=A+B cos[C cos ω₀t+ϕ(t)] (5)

In the Formula (5), C cos ω₀t represents a phase generated carrier; C represents the amplitude, and wo represents carrier frequency; ϕ(t)=D cos ωₛt+ψ(t), D cos ωₛt represents the phase change caused by the disturbance signal of the sensing optical fiber 30; D represents the amplitude; ωₛ represents a sound field signal frequency; and ψ(t) represents the slow change of the initial phase caused by environmental disturbance and the like. The Formula (5) is obtained by expanding a Bessel function:

$$I = A + B \{ [ {J}_{0} ( C ) + 2 {\sum }_{k = 0}^{∞} {( - 1 )}^{k} {J}_{2 k} ( C ) cos 2 k {ω}_{0} t ] cos ϕ ( t ) - 2 [ {\sum }_{k = 0}^{∞} {( - 1 )}^{k} {J}_{2 k + 1} ( C ) cos ( 2 k + 1 ) {ω}_{0} t ] sin ϕ ( t ) \} \qquad ( 6 )$$

In the Formula (6), Jₙ(m) represents a n-order Bessel function value under an m modulation depth, k=0 and k=1, and thus a high quality signal and a frequency-doubled signal can be obtained.

After the Bessel function expansion, a multiplication is carried out for the detector signal I output by the interferometer by multiplying a fundamental frequency signal (the amplitude is G) and a frequency doubling signal (the amplitude is H). In order to overcome blanking and distortion phenomena of the signals along with fluctuation of an external interference signal, Differential Cross Multiplication (DCM) is carried out on the two paths of signals; and the signals after the differential cross multiplication are subjected to differential amplification and integral operation processing, and is converted as follows:

B²GHJ₁(C)J₂(C)φ(t) (7)

φ(t)=D cos ωₛt+ψ (t) is substituted into the Formula (7) to obtain:

B²GHJ₁(C)J₂(C)[D cos ωₛt+ψ(t)] (8)

Therefore, the signals obtained after integration comprise a to-be-detected signal D cos ωₛt and external environment information. The latter is usually a slow-change signal, and its amplitude may be very large; and the slow-change signal can be filtered through a high-pass filter. Finally, the output is shown as follows:

B²GHJ₁(C)J₂(C)D cos ωₛt (9)

The D cos ωₛt signal of phase change caused by the disturbance signal of the sensing optical fiber 30 can be solved through the Formula (7).

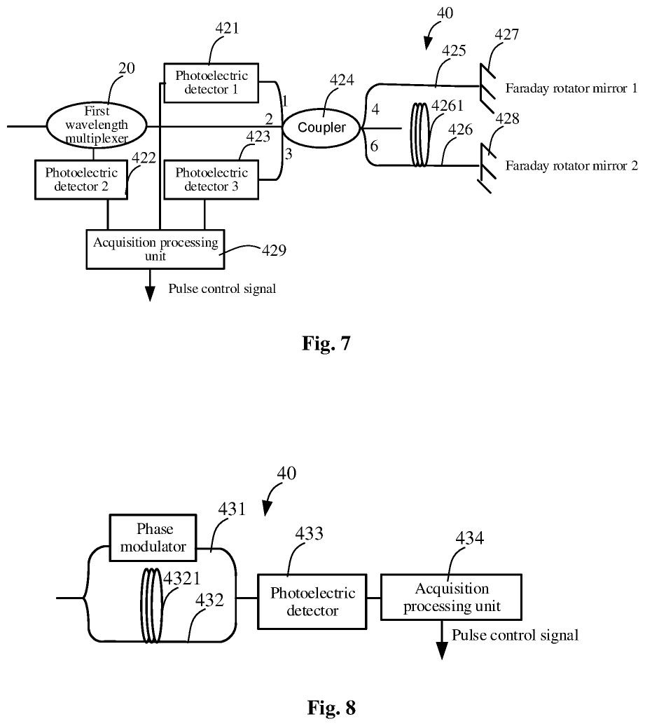

FIG. 7 is the basic structure schematic diagram of the second control demodulation module provided by the embodiment of the present application. As shown in FIG. 7, the embodiment adopts a 3×3 coupler phase demodulation mode based on the Michelson interferometer; and this module mainly includes the coupler 424, the first interference arm 425, the second interference arm 426, the Faraday rotator mirrors 427, 428, a first photoelectric detector 421, a second photoelectric detector 422, a third photoelectric detector 423, a third wavelength division multiplexer and the acquisition processing unit 429.

The first end of the coupler 424 is connected to a third port of the first wavelength division multiplexer 20, the second end of the coupler 424 is connected to one end of the first interference arm 425 and one end of the second interference arm 426, and the other end of the first interference arm 425 and the other end of the second interference arm 426 are respectively connected to the Faraday rotator mirrors 427, 428. In addition, the phase matching ring 4261 is arranged on the second interference arm 426, the length L of the phase matching ring 4261 meets the condition L≤Lo/2, wherein Lₒ represents the coherence length of pulsed light. Certainly, the phase matching ring 4261 can also be arranged on the first interference arm 425.

The first photoelectric detector 421, the second photoelectric detector 422 and the third photoelectric detector 423 are all connected to the coupler 424 for receiving the backward Rayleigh scattering interference light returned by the first interference arm 425 and the second interference arm 426 and generating corresponding electric signals according to the backward Rayleigh scattering interference light.

The backward Rayleigh scattering light is incident to a port 2 of the coupler 424 through the first wavelength division multiplexer 20 and is split into two paths of light signals through the port 2 of the coupler 424. One path of light enters a port 4 of the coupler 424, and returns to the port 4 of the coupler 424 through the first interference arm 425 and the Faraday rotator mirror 427. The other path of light enters a port 6 of the coupler 424, and returns to the port 6 of the coupler 424 through the second interference arm 426 and the Faraday rotator mirror 428. The two paths of lights are subjected to beam combination interference at the coupler 424. The backward Rayleigh scattering interference light enters the first photoelectric detector 421 and the third photoelectric detector 423 through the port 1 and the port 3 of the coupler 424. And the backward Rayleigh scattering interference light enters the second photoelectric detector 422 through the port 2 of the coupler 424 and the first wavelength division multiplexer 20.

The light intensity expression obtained by three detectors is shown as follows:

Iₚ=D+I₀ cos[ϕ(t)−(p−1)×(2π/3)],p=1,2,3 (10)

In the Formula (8), ϕ(t)=ϕ(t)+ψ(t); D represents an interference signal direct current component; I₀ represents an interference signal alternating current component amplitude; p represents a serial number of light signals received by the detectors, and p=1, 2, 3; ϕ(t) represents a phase difference signal caused by the disturbance signals, in the unit of rad; and ψ(t) represents a phase difference signal caused by environmental noise, in the unit of rad.

Then, phase demodulation on the light signals received by the three detectors is carried out by the acquisition processing unit 429 so as to obtain the phase change, caused by the disturbance signal in the sensing optical fiber 30, of the pulsed light of one wavelength. In addition, the acquisition processing unit 429 is also configured to demodulate the power change of the backward Rayleigh scattering light, caused by temperature change, of the pulsed light of each wavelength.

FIG. 8 is the basic structure schematic diagram of the third control demodulation module provided by the embodiment of the present application. As shown in FIG. 8, the embodiment adopts a PGC phase demodulation mode based on a Mach-Zehnder interferometer; and this module mainly includes the first interference arm 431, the second interference arm 432, the photoelectric detectors 433 and the acquisition processing unit 434.

The third port of the first wavelength division multiplexer 20 is connected to one end of the first interference arm 431 and one end of the second interference arm 432 respectively, and the other end of the first interference arm 431 and the other end of the second interference arm 432 are connected to the photoelectric detectors 433 respectively. In addition, the phase matching ring 4321 is arranged on the second interference arm 432, and the length L of the phase matching ring 4321 meets the condition L≤L₀, wherein Lₒ represents the coherence length of pulsed light. Certainly, the phase matching ring 4321 can also be arranged on the first interference arm 431.

The photoelectric detector 433 is configured to receive the backward Rayleigh scattering interference light output by the first interference arm 431 and the second interference arm 432 and generate a corresponding electric signal according to the backward Rayleigh scattering interference light. The acquisition processing unit 434 is connected to the photoelectric detectors 433 for processing the electric signal output by the photoelectric detectors and demodulating phase change, caused by the disturbance signal in the sensing optical fiber, of the pulsed light of one wavelength, and the power change of the backward Rayleigh scattering light, caused by the temperature change, of the pulsed light of each wavelength.

Each embodiment in this specification is described in a progressive manner. The same and similar parts between each embodiment can be seen from each other. Each embodiment focuses on the differences from other embodiments.

Those skilled in the art will easily think of other embodiments of the present application after considering the specification and practicing the present application herein. The present application is intended to cover any variant, use or adaptive change of the present application, which follows the general principles of the present application and includes the common general knowledge or conventional technical means in the technical field that are not invented by the present application. The description and embodiments are only regarded as illustrative. The true scope and spirit of the present application are indicated by the following claims.

It should be understood that the present application is not limited to the precise structure described above and shown in the drawings, and various modifications and changes can be made without departing from its scope. The scope of the present application is limited only by the appended claims.

1. A continuous spatial synchronization monitoring device for ocean temperature and pressure, comprising:
a multi-wavelength laser module which comprises a broadband light source, a pulse controller and a phase shifted fiber bragg grating unit, wherein the pulse controller is configured to convert broadband light output by the broadband light source into broadband pulsed light, and the phase shifted fiber bragg grating unit is configured to demodulate the pulsed light arranged by a time sequence and having multiple different wave-lengths from the broadband pulsed light;
a first wavelength division multiplexer of which a first port is connected to an output end of the multi-wavelength laser module, and a second port is connected to a sensing optical fiber for injecting the pulsed light having different wave-lengths into the sensing optical fiber;
the sensing optical fiber placed in seawater, wherein backward Rayleigh scattering light can be generated by the pulsed light having different wave-lengths when transmitted in the sensing optical fiber; and
a control demodulation module which is connected to the second port of the first wavelength division multiplexer for receiving the backward Rayleigh scattering light, demodulating the backward Rayleigh scattering light and calculating temperature and pressure values of the seawater at all points around the sensing optical fiber.

2. The continuous spatial synchronization monitoring device for ocean temperature and pressure according to claim 1, wherein the multi-wavelength laser module further comprises a second wavelength division multiplexer,
wherein a first port of the second wavelength division multiplexer is connected to an output end of the pulse controller, a second port of the second wavelength division multiplexer is connected to the phase shifted fiber bragg grating unit, and a third port of the second wavelength division multiplexer is connected to the first port of the first wavelength division multiplexer; and
wherein the phase shifted fiber bragg grating unit comprises an optical fiber, and a plurality of reflective phase shifted fiber bragg gratings having different central window wave-lengths are arranged on the optical fiber.

3. The continuous spatial synchronization monitoring device for ocean temperature and pressure according to claim 1, wherein the multi-wavelength laser module further comprises a second wavelength division multiplexer,
wherein the first port of the second wavelength division multiplexer is connected to the output end of the pulse controller, the second port of the second wavelength division multiplexer is connected to the phase shifted fiber bragg grating unit, and the third port of the second wavelength division multiplexer is connected to the first port of the first wavelength division multiplexer; and
wherein the phase shifted fiber bragg grating unit comprises a plurality of optical fibers; a reflective phase shifted fiber bragg grating is arranged on each optical fiber;
and the central window wave-lengths of the phase shifted fiber bragg gratings on each optical fiber are different.

4. The continuous spatial synchronization monitoring device for ocean temperature and pressure according to claim 1, wherein the phase shifted fiber bragg grating unit comprises a plurality of optical fibers; a transmissive phase shifted fiber bragg grating is arranged on each optical fiber; and the central window wave-lengths of the phase shifted fiber bragg gratings on each optical fiber are different; and
one end of each optical fiber is connected to the output end of the pulse controller, and the other end of each optical fiber is connected to the first port of the first wavelength division multiplexer.

5. The continuous spatial synchronization monitoring device for ocean temperature and pressure according to claim 1, wherein the multi-wavelength laser module further comprises an erbium-doped fiber amplifier,
wherein the erbium-doped fiber amplifier is connected to first port of the first wavelength division multiplexer for amplifying an amplitude of multiple pieces of pulsed light having different wave-lengths and then outputting the pulsed light to the first port of the first wavelength division multiplexer.

6. The continuous spatial synchronization monitoring device for ocean temperature and pressure according to claim 1, wherein the control demodulation module comprises a coupler, a first interference arm, a second interference arm, Faraday rotator mirrors, photoelectric detectors and an acquisition processing unit,
wherein a first end of the coupler is connected to a third port of the first wavelength division multiplexer, and a second end of the coupler is connected with one end of the first interference arm and one end of the second interference arm; the other end of the first interference arm and the other end of the second interference arm are respectively connected to one of the Faraday rotator mirrors; a phase matching ring is arranged on the first interference arm or the second interference arm, the length of the phase matching ring being L≤Lo/2, wherein Lₒ represents the coherence length of pulsed light;
wherein the photoelectric detector is connected to a third end of the coupler for receiving backward Rayleigh scattering interference light returned by the first interference arm and the second interference arm and generating corresponding electric signals according to the backward Rayleigh scattering interference light; and
wherein the acquisition processing unit is connected to the photoelectric detectors for processing the electric signals output by the photoelectric detectors and demodulating phase changes, caused by a disturbance signal in the sensing optical fiber, of the pulsed light of one wavelength and power changes of the backward Rayleigh scattering light, caused by temperature change, of the pulsed light of each wavelength.

7. The continuous spatial synchronization monitoring device for ocean temperature and pressure according to claim 1, wherein the control demodulation module comprises a coupler, a first interference arm, a second interference arm, Faraday rotator mirrors, a first photoelectric detector, a second photoelectric detector, a third photoelectric detector and an acquisition processing unit,
wherein the first end of the coupler is connected to a third port of the first wavelength division multiplexer, and the second end of the coupler is connected to one end of the first interference arm and one end of the second interference arm; the other end of the first interference arm and the other end of the second interference arm are respectively connected to one of the Faraday rotator mirrors; a phase matching ring is arranged on the first interference arm or the second interference arm, the length of the phase matching ring being L≤Lo/2, wherein Lₒ represents the coherence length of pulsed light;
wherein the first photoelectric detector, the second photoelectric detector and the third photoelectric detector are all connected to the coupler for receiving the backward Rayleigh scattering interference light returned by the first interference arm and the second interference arm and generating corresponding electric signals according to the backward Rayleigh scattering interference light; and
wherein the acquisition processing unit is connected to the first photoelectric detector, the second photoelectric detector and the third photoelectric detector for processing the electric signals output by the first photoelectric detector, the second photoelectric detector and the third photoelectric detector, and demodulating phase changes, caused by disturbance signal in the sensing optical fiber, of the pulsed light of one wavelength and power changes of the backward Rayleigh scattering light, caused by temperature change, of the pulsed light of each wavelength.

8. The continuous spatial synchronization monitoring device for ocean temperature and pressure according to claim 1, wherein the control demodulation module comprises a first interference arm, a second interference arm, photoelectric detectors and an acquisition processing unit,
wherein a third port of the first wavelength division multiplexer is connected to one end of the first interference arm and one end of the second interference arm respectively, and the other end of the first interference arm and the other end of the second interference arm are connected to the photoelectric detectors respectively; a phase matching ring is arranged on the first interference arm or the second interference arm, the length of the phase matching ring being L≤L₀, wherein Lₒ represents the coherence length of pulsed light;
wherein the photoelectric detectors are configured to receive the backward Rayleigh scattering interference light output by the first interference arm and the second interference arm and generate corresponding electric signals according to the backward Rayleigh scattering interference light; and
wherein the acquisition processing unit is connected to the photoelectric detectors for processing the electric signals output by the photoelectric detectors, and demodulating phase changes, caused by disturbance signal in the sensing optical fiber, of the pulsed light of one wavelength and power changes of the backward Rayleigh scattering light, caused by temperature change, of the pulsed light of each wavelength.

9. The continuous spatial synchronization monitoring device for ocean temperature and pressure according to claim 6, wherein the acquisition processing unit is also connected with a control end of the pulse controller for outputting a pulse control signal to the pulse controller so as to control the output of the broad-spectrum pulsed light of the pulse controller.
